(19) United States
(12) Patent Application Publication
(10) Pub. No.: US 2012/0076631 A1
(43) Pub. Date: Mar. 29, 2012

(54) FEEDING DEVICE

(75) Inventors: HUI WANG, Shenzhen City (CN); WEI-HUA LIU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/186,658

(22) Filed: Jul. 20, 2011

(30) Foreign Application Priority Data
Sep. 24, 2010 (CN) 201010289253.7

(51) Int. Cl. B65G 49/00; B65G 57/00

(52) U.S. Cl. 414/792.7

(57) ABSTRACT

A feeding device transferring feeding trays with workpieces between a first station and a second station includes a fixing frame, a first conveying mechanism, a second conveying mechanism, and a stacking mechanism. The first conveying mechanism is mounted on the fixing frame for conveying feeding trays to the first station one by one. The second conveying mechanism is mounted on the fixing frame for conveying the feeding trays from the first station one by one, and is connected to the first conveying mechanism. The stacking mechanism is mounted on the fixing frame for stacking the feeding trays together.

### BACKGROUND

1. Technical Field

The present disclosure relates to feeding devices, and particularly, to a feeding device for transferring feeding trays.

2. Description of the Related Art

During a production process, workpieces are placed in feeding trays, and the feeding trays are transferred between different machining stations by a conveying line. If feeding trays are reused, the conveying line becomes sinuous, which occupies too much space. For workpieces that need to be held in a specific position before conveying to next machining station, the conveying line needs to be elongated, further occupying even more space.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is an assembled, isometric view of one embodiment of a feeding device with feeding trays and workpieces, and including a first conveying mechanism, a second conveying mechanism, a stacking mechanism, and a handling mechanism.

FIG. 2 is an assembled, isometric view of a distributing member of the first conveying mechanism in FIG. 1.

FIG. 3 is an assembled, isometric view of a conveying member with a feeding tray of the first conveying mechanism in FIG. 1.

FIG. 4 is an assembled, isometric view of an elevating member of the second conveying mechanism with a feeding tray in FIG. 1.

FIG. 5 is an assembled, isometric view of a conveying member of the second conveying mechanism in FIG. 1.

FIG. 6 is an assembled, isometric view of the stacking mechanism with a feeding tray in FIG. 1.

FIG. 7 is an assembled, isometric view of the handling mechanism in FIG. 1.

FIG. 8 is a partial, enlarged view of the handling mechanism shown in FIG. 7.

### DETAILED DESCRIPTION

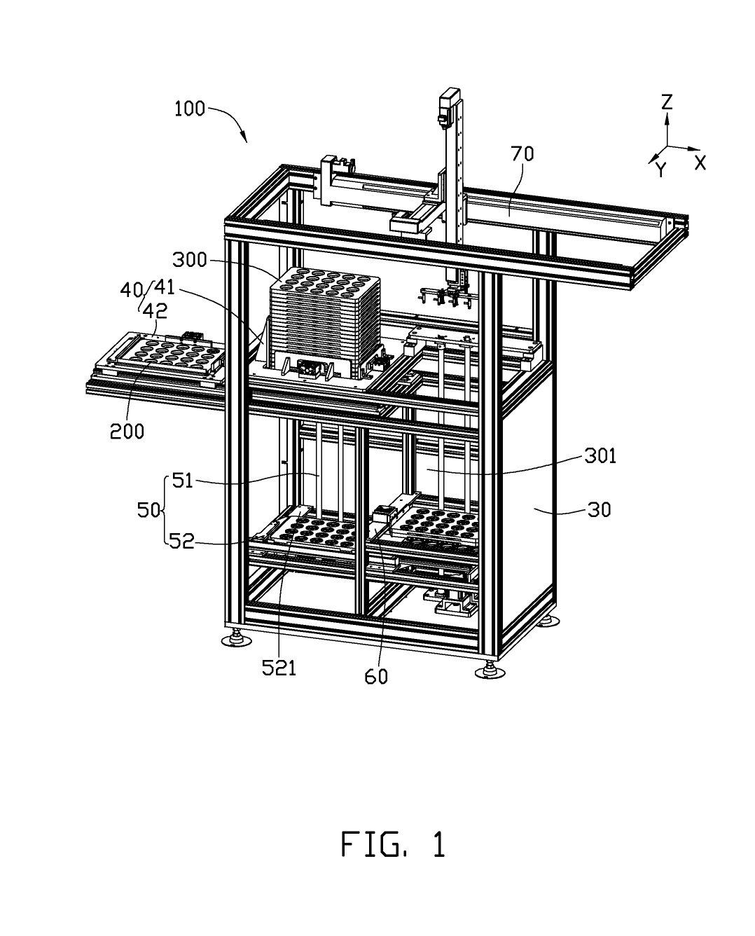

Referring to FIG. 1, one embodiment of a feeding device 100 is used for transferring feeding trays 300 for receiving workpieces 200 between a first station and a second station. The feeding device 100 includes a fixing frame 30, a first conveying mechanism 40, a second conveying mechanism 50, a stacking mechanism 60, and a handling mechanism 70. In the illustrated embodiment, the workpiece 200 is formed by injection, and then transferred from an injection station to a testing station for testing a size of the workpiece 200. When the workpiece 200 is newly formed, the temperature of the workpiece 200 is relatively high, and the size of the workpiece 200 is affected by the temperature. Therefore, the workpiece 200 needs to be cooled down to room temperature before testing, such that the feeding time between the injection station and the testing station is equal to or longer than the cooling time.

The fixing frame 30 is substantially rectangular, and defines a receiving space 301 for receiving the above-mentioned components of the feeding device 100.

The first conveying mechanism 40 is used for conveying the stacked feeding trays 300 to a first station one by one. The first conveying mechanism 40 is substantially L-shaped, and is partly received in the receiving space 301. Additionally, the first conveying mechanism 40 includes a distributing member 41 and a conveying member 42. The distributing member 41 is used for distributing the feeding tray 300 to the conveying member 42. The conveying member 42 is used for conveying the distributed feeding tray 300 to the first station.

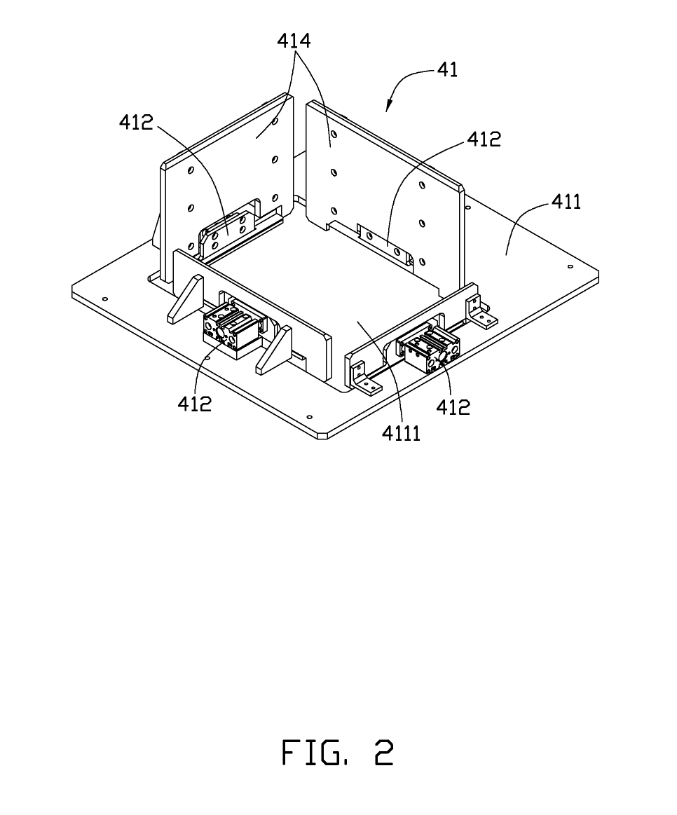

Referring also to FIG. 2, in the illustrated embodiment, the distributing member 41 is placed on the conveying member 42, and includes a fixing base 411, four air cylinders 412, and two stop boards 414. The fixing base 411 is substantially rectangular, and defines a distributing opening 4111 in the center. The four air cylinders 412 are placed on four sides of the fixing base 411 adjacent to the distributing opening 4111, respectively. Two stop boards 414 are placed on the fixing base 411 adjacent to the distributing opening 4111 for positioning the feeding trays 300. A first pair of air cylinders 412 opposite to each other can fix the bottom one of the stacked feeding trays 300, and a second pair of air cylinders 412 opposite to each other can fix another feeding tray 300 adjacent to the bottom feeding tray 300. When distributing feeding trays 300, the first pair of cylinders 412 retracts, the bottom feeding tray 300 is distributed to the conveying member 42, and then the stacked feeding trays 300 move down together a distance of the height of one feeding tray 300, and at the same time the second pair of air cylinders 412 starts to fix the new bottom feeding tray 300.

It is understood that the number of the air cylinders 412 can be changed as needed. For example, two air cylinders 412 can be employed, and be placed on two adjacent sides to fix the feeding tray 300, respectively.

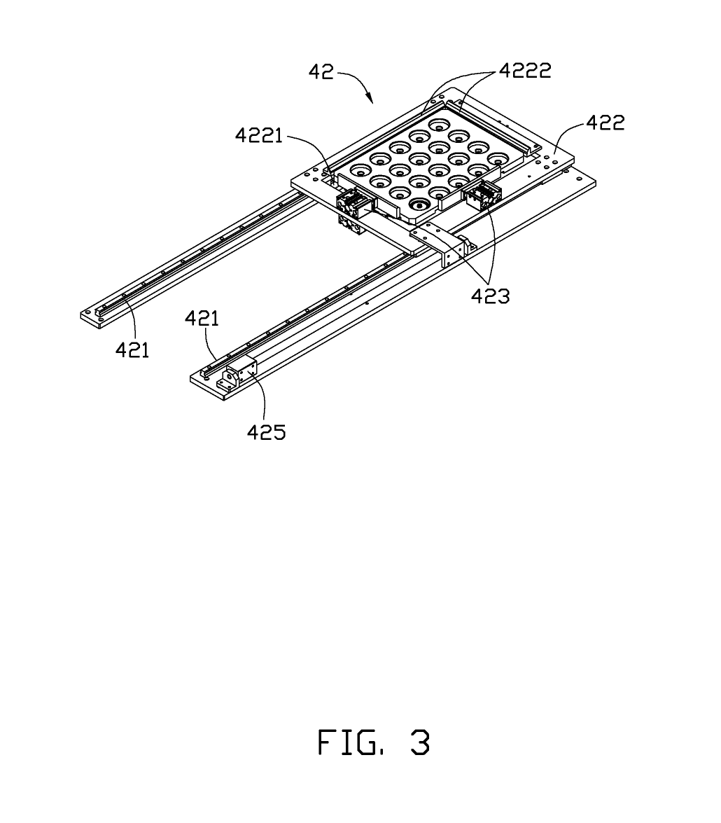

Referring also to FIG. 3, in the illustrated embodiment, the conveying member 42 includes two parallel guiding rails 421, a sliding base 422, two air cylinders 423, and a rodless cylinder 425. The sliding base 422 is substantially rectangular, and is slidably placed along the guiding rails 421. A distributing opening 4221 is defined in a center of the sliding base 422. The air cylinders 423 are placed on two adjacent sides of the sliding base 422 adjacent to the distributing opening 4221, respectively, for fixing the feeding tray 300. The rodless cylinder 425 is placed on one guiding rail 421 for driving the sliding base 422. When conveying the feeding tray 300 to the injection station, the air cylinders 423 first cooperatively fix the feeding tray 300 distributed by the distributing member 41. The rodless cylinder 425 then drives the sliding base 422 to slide along the guiding rail 421 to a first end of the guiding rail 421. Lastly, when the feeding tray 300 is fed with a predetermined number of workpieces 200, the rodless cylinder 425 drives the sliding base 422 to slide to a second end of the guiding rail 421 opposite to the first end.

It is understood that the numbers of the guiding rail 421, the air cylinder 423, and the rodless cylinder 425 can be changed as needed.

The second conveying mechanism 50 is substantially L-shaped, and is received in the receiving space 301. The second conveying mechanism 50 includes an elevating member 51 and a conveying member 52, and is used for conveying the feeding trays 300 from the first station to the stacking mechanism 60 one by one. The elevating member 51 is used for moving the feeding tray 300 from the first station to the conveying member 52. The conveying member 52 is used for conveying the feeding tray 300 to the second station.

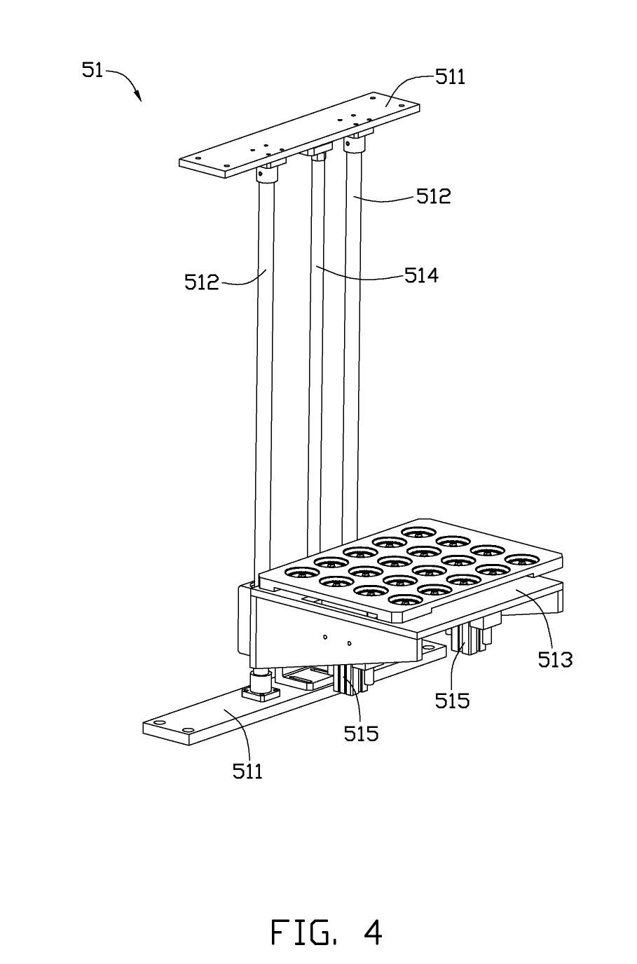

Referring also to FIG. 4, in the illustrated embodiment, the elevating member 51 is placed below the distributing member 41 and the conveying member 42, for transferring the feeding trays 300 from the conveying member 42 to the conveying member 52. The elevating member 51 includes two mounting bases 511, two guiding posts 512, a platform 513, a rodless cylinder 514, and two air cylinders 515. The two mounting bases 511 are fixed to the opposite ends of the fixing frame 30, and are adjacent to the conveying members 42, 52, respectively. Opposite ends of the guiding post 512 are connected to the two mounting bases 511, respectively. The platform 513 is slidably connected to the guiding posts 512. The size of the platform 513 is slightly smaller than that of the feeding tray 300. Two openings (not shown) are defined in the platform 513. Opposite ends of the rodless cylinder 514 are connected to the two mounting bases 511, respectively. The rodless cylinder 514 is placed between the two guiding posts 512, for elevating the platform 513. The air cylinders 515 are mounted on the platform 513, and are adjacent to the two openings, respectively, for lifting the feeding tray 300 onto the platform 513.

It is understood that the numbers of the guiding post 152, the rodless cylinder 514, and the air cylinder 515 can be changed as needed.

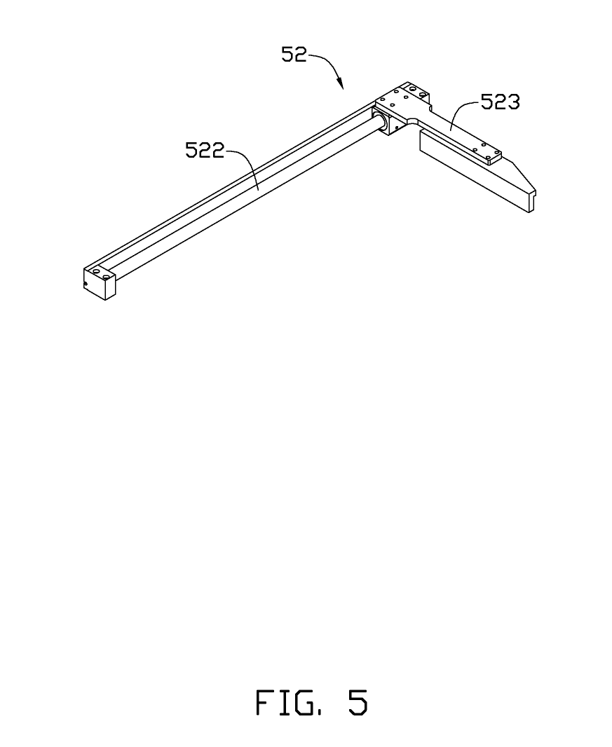

Referring also to FIG. 5, in the illustrated embodiment, the conveying member 52 includes two support strips 521 (shown in FIG. 1), a rodless cylinder 522 and a pushing bar 523. The support strips 521 are fixed to the fixing frame 30, and are aligned to support opposite sides of the feeding tray 300. The rodless cylinder 522 is fixed on the two support strips 521, and is substantially perpendicular to the rodless cylinder 514 of the elevating member 51. The pushing bar 523 is connected to the rodless cylinder 522 for moving the feeding tray 300 from the second conveying mechanism 50 to the stacking mechanism 60.

When the rodless cylinder 425 of the first conveying member 42 drives the feeding tray 300 to the opposite end of the guiding rail 421 of the first conveying member 42, the air cylinders 423 of the first conveying member 42 retract such that the feeding tray 300 is placed on the platform 513 of the elevating member 51. The air cylinders 515 then start to lift the feeding tray 300, and the platform 513 moves down along the guiding posts 512. When the platform 513 goes through the conveying member 52, the feeding tray 300 is placed on the support strips 521 because the size of the feeding tray 300 is greater than that of the platform 513. The feeding tray 300 is then moved to the stacking mechanism 60 by the rodless cylinder 522.

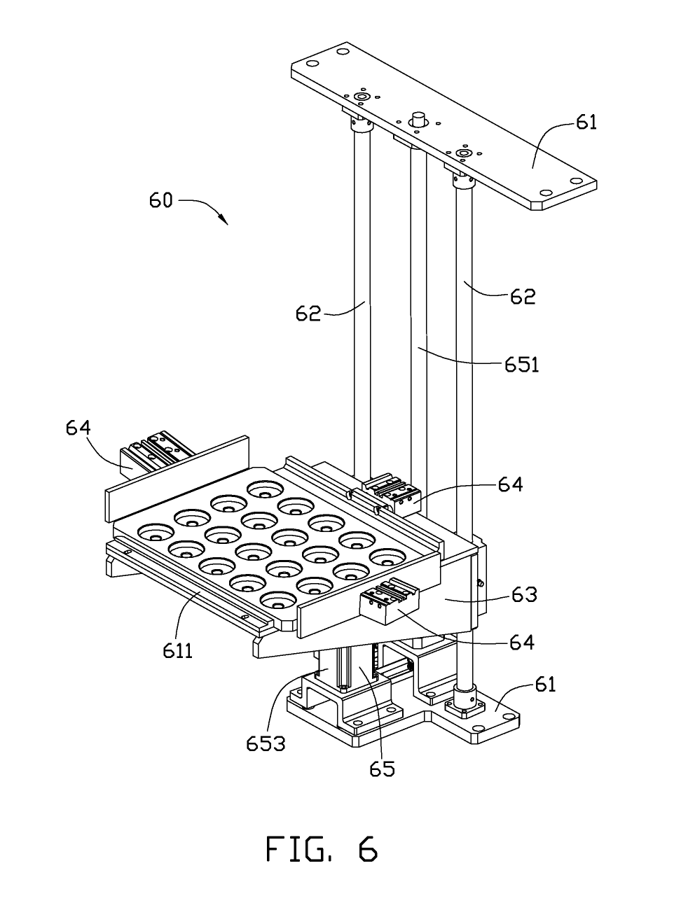

Referring also to FIG. 6, the stacking mechanism 60 is fixed to the fixing frame 30, and is parallel to the elevating member 51 of the second conveying mechanism 50. In the illustrated embodiment, the stacking mechanism 60 includes two fixing bases 61, two guiding posts 62, a platform 63, three air cylinders 64, and a driving assembly 65. The fixing bases 61 are fixed to the fixing frame 30, and are adjacent to the distributing member 41 and the conveying member 52, respectively. Opposite ends of the guiding posts 62 are connected to the fixing bases 61, respectively. The platform 63 is slidably fixed to the guiding posts 62. One cylinder 64 is placed on the platform 63, and the other two air cylinders 64 are oppositely placed on the fixing frame 30 between the two fixing bases 61 (referring to FIG. 1). The driving assembly 65 includes a threaded rod 651, a nut (not shown), and a motor 653. The threaded rod 651 is fixed to the fixing bases 61 between the two guiding posts 62, and is substantially parallel to the guiding posts 62. The nut is connected to the platform 63, and is engaged with the threaded rod 651. The motor 653 is mounted on one fixing base 61 adjacent to the conveying member 52, and is connected to and drives the threaded rod 651.

When stacking the feeding trays 300, one feeding tray 300 is moved onto the platform 63 from the conveying member 52 of the second conveying mechanism 50, and is fixed by the air cylinder 64 placed on the platform 63. Subsequently, the driving assembly 65 elevates the platform 63 with the feeding tray 300 to the appointed place where the feeding tray 300 is substantially coplanar with the other two air cylinders 64 such that the feeding tray 300 can be fixed by the other two air cylinders 64. The platform 63 is moved down by the driving assembly 65, and another feeding tray 300 is moved onto the platform 63. The platform 63 with the workpiece 300 is then elevated near the feeding tray 300 fixed by the two air cylinders 64. When the two air cylinders 64 retract, the platform 63 simultaneously elevates and the feeding tray 300 on the platform 63 supports the feeding tray 300 fixed by the two cylinders 64. Finally, the feeding tray 300 is substantially coplanar to the two cylinders 64, and is fixed by the two cylinders 64 such that the two feeding trays 300 are stacked together.

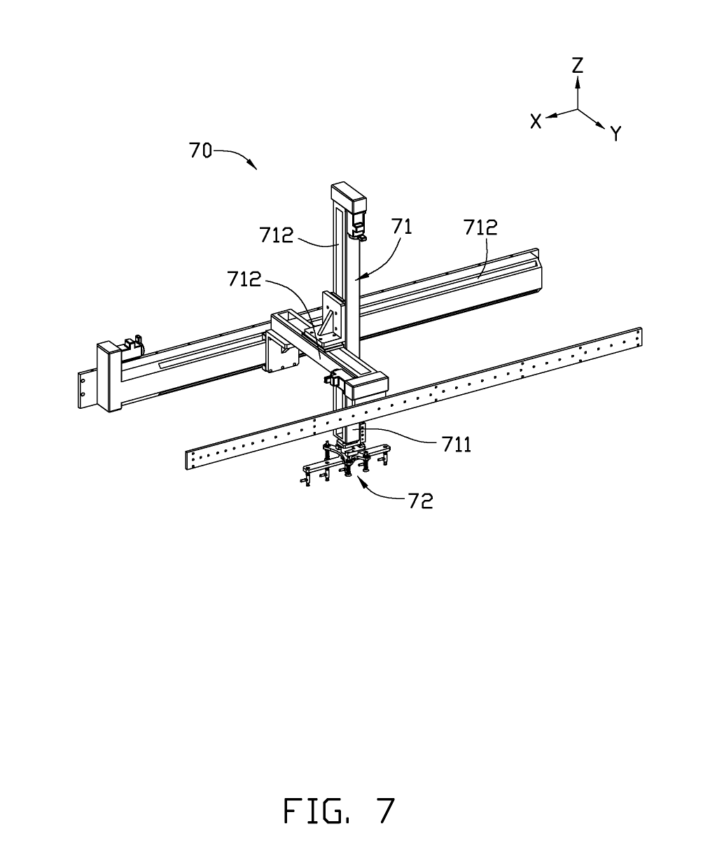

Referring also to FIG. 7, the handling mechanism 70 is placed on a top of the fixing frame 30, and includes a manipulator 71, a handling assembly 72, and an air cylinder 73.

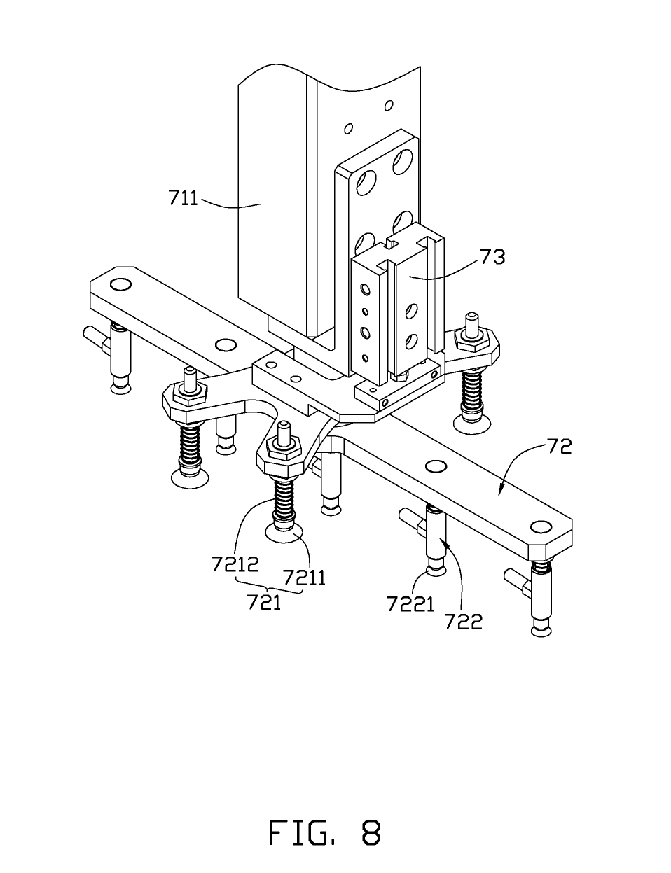

Referring also to FIG. 8, in the illustrated embodiment, the manipulator 71 is a triaxial manipulator, and includes an arm 711 and three guiding rails 712. A first of the three guiding rails 712 is along the X-axis, a second of the three guiding rails 712 is along the Y-axis, and a third of the three guiding rails 712 is along the Z-axis. The arm 711 can slide on the guiding rails 712. The handling assembly 72 is mounted on one end of the arm 711, and includes a first handling member 721 and a second handling member 722. The first handling member 721 includes a handling portion 7211 and a cushion portion 7212, for handling the feeding trays 200. The handling portion 7211 is connected to the cushion portion 7212, and is a sucking cup in this embodiment. The second handling member 722 includes a handling portion 7221, for handling the workpieces 300. It is understood that the second handling member 722 can also include a cushion portion, and the handling portions 7211, 7221 can employ other structures, such as jaws. The air cylinder 73 is placed on the manipulator 71 for driving the first handling member 721 such that when the handling assembly 72 is working, the first handling member 721 and the second handling member 722 are staggered along the Z-axis.

When handling the workpieces 300, the arm 711 drives the second handling member 722 on the top of the workpieces 300 along the Y-axis, and the air cylinder 73 drives the first handling member 721 along the opposite direction of the second handling member 722, such that the second handling member 722 moves towards the workpieces 200 along the Z-axis, and then handles the workpieces 200 to the appointed place. When handling the feeding trays 300, the process is similar to that of handling the workpieces 200, but the first handling member 721 handles the feeding tray 300 to the top of the distributing member 41, for reusing the feeding trays 300.

It is understood that the handling mechanism 70 can be omitted, and the workpieces 200 and the feeding trays 300 can be handled by people.

The feeding trays 300 and the workpieces 200 can be stacked together automatically due to the stacking mechanism 60, and the feeding device 100 is compact. Thus, the needed space is relatively smaller even though the time between the two stations is relatively long.

It is to be understood, however, that even through numerous characteristics and advantages of the disclosure have been set forth in the foregoing description, together with details of the structure and function of the embodiments, the disclosure is illustrative only, and changes may be made in detail, especially in matters of shape, size, and arrangement of parts within the principles of the embodiments to the full extent indicated by the broad general meaning of the terms in which the appended claims are expressed.

What is claimed is:

1. A feeding device for transferring feeding trays with workpieces between a first station and a second station, comprising:
a fixing frame;
a first conveying mechanism mounted on the fixing frame and conveying feeding trays to the first station one by one;
a second conveying mechanism mounted on the fixing frame and connected to the first conveying mechanism, the second conveying mechanism conveying the feeding trays from the first station one by one; and
a stacking mechanism mounted on the fixing frame and stacking the feeding trays together, wherein the stacking mechanism comprises a platform, a driving assembly, and two air cylinders, the platform is connected to and moved by the driving assembly, one of the two air cylinders is mounted on the platform to fix the feeding tray on the platform, and the other of the two air cylinders are mounted on the fixing frame to fix the feeding tray on the appointed place.

2. The feeding device of claim 1, wherein the driving assembly comprises a threaded rod, a nut, and a motor, the threaded rod is engaged with the nut, and the motor is connected to and drives the threaded rod.

3. The feeding device of claim 1, wherein the stacking mechanism further comprises one guiding post substantially parallel to the threaded rod, and the platform is slidably fixed to the guiding post.

4. The feeding device of claim 1, wherein the first conveying mechanism comprises a distributing member and a conveying member below the distributing member, the distributing member distributes the feeding trays, and the conveying member conveys the distributed feeding trays.

5. The feeding device of claim 4, wherein the distributing member comprises a fixing base and two air cylinders, a distributing opening is defined in the fixing base, and the air cylinders are placed on two sides of the fixing base adjacent to the distributing opening, to fix the feeding trays.

6. The feeding device of claim 1, wherein the second conveying mechanism comprises a conveying member and an elevating member moving the feeding trays from the first station to the conveying member, and the conveying member conveys the feeding tray to the second station.

7. The feeding device of claim 6, wherein the elevating member comprises a platform, a rodless cylinder, and an air cylinder, the platform is connected to and elevated by the rodless cylinder, and the air cylinder is placed on the platform to lift the feeding tray on the platform.

8. The feeding device of claim 1, wherein the feeding device further comprises a handling mechanism handling the feeding trays or the workpieces, the handling mechanism is placed on a top of the fixing frame, and comprises a manipulator and a handling assembly connected to the manipulator.

9. A feeding device for transferring feeding trays with workpieces between a first station and a second station, comprising:
a fixing frame;
a first conveying mechanism mounted on the fixing frame and conveying feeding trays to the first station one by one, the first conveying mechanism comprising a distributing member and a conveying member below the distributing member, the distributing member distributing the feeding trays, and the conveying member conveying the distributed feeding trays to the first station;
a second conveying mechanism mounted on the fixing frame, and connected to the first conveying mechanism, the second conveying mechanism conveying the feeding trays from the first station one by one; and
a stacking mechanism mounted on the fixing frame and stacking the feeding trays together.

10. The feeding device of claim 9, wherein the distributing member comprises a fixing base and two air cylinders, a distributing opening is defined in the fixing base, the air cylinders are placed on two sides of the fixing base adjacent to the distributing opening, to fix the feeding trays.

11. The feeding device of claim 9, wherein the stacking mechanism comprises a platform, a driving assembly, and two air cylinders, the platform is connected to and moved by the driving assembly, the driving assembly comprises a threaded rod, a nut, and a motor, the threaded rod is engaged with the nut, the motor is connected to and drives the threaded rod, one of the air cylinders is mounted on the platform to fix the feeding tray on the platform, and the other of the air cylinders is mounted on the fixing frame to fix the feeding tray on the appointed place.

12. The feeding device of claim 11, wherein the stacking mechanism further comprises one guiding post substantially parallel to the threaded rod, and the platform is slidably fixed to the guiding post.

13. The feeding device of claim 9, wherein the second conveying mechanism comprises an elevating member and a conveying member, the elevating member moves the feeding tray from the first station to the conveying member, and the conveying member conveys the feeding tray to the second station.

14. The feeding device of claim 13, wherein the elevating member comprises a platform, a rodless cylinder, and an air cylinder, the platform is connected to and elevated by the rodless cylinder, and the air cylinder is placed on the platform to lift the feeding tray on the platform.

15. The feeding device of claim 9, wherein the feeding device further comprises a handling mechanism handling the feeding trays or the workpieces, the handling mechanism is placed on a top of the fixing frame, and comprises a manipulator and a handling assembly connected to the manipulator.

16. A feeding device for transferring feeding trays with workpieces between a first station and a second station, comprising:
a fixing frame;
a first conveying mechanism mounted on the fixing frame and conveying feeding trays to the first station one by one;
a second conveying mechanism mounted on the fixing frame, and connected to the first conveying mechanism, the second conveying mechanism conveying the feeding trays from the first station one by one, the second conveying mechanism comprising an elevating member and a conveying member, the elevating member moving the feeding tray from the first station to the conveying member, and the conveying member conveying the feeding tray to the second station; and
a stacking mechanism mounted on the fixing frame stacking the feeding trays together.

17. The feeding device of claim 16, wherein the stacking mechanism comprises a platform, a driving assembly, and two air cylinders, the platform is connected to and moved by the driving assembly, the driving assembly comprises a threaded rod, a nut, and a motor, the threaded rod is engaged with the nut, the motor is connected to and drives the threaded rod, one of the air cylinders is mounted on the platform to fix the feeding trays on the platform, and the other of the air cylinders is mounted on the fixing frame to fix the feeding trays on the appointed place.

18. The feeding device of claim 16, wherein the elevating member comprises a platform, a rodless cylinder, and an air cylinder, the platform is connected to and elevated by the rodless cylinder, and the air cylinder is placed on the platform to lift the feeding tray on the platform.

19. The feeding device of claim 16, wherein the first conveying mechanism comprises a distributing member and a conveying member below the distributing member, the distributing member distributes the feeding tray, the conveying member conveys the distributed feeding tray to the first station, the distributing member comprises a fixing base and two air cylinders, a distributing opening is defined in the fixing base, and the air cylinders are placed on two sides of the fixing base adjacent to the distributing opening, to fix the feeding trays.

20. The feeding device of claim 16, wherein the feeding device further comprises a handling mechanism handling the feeding trays or the workpieces, the handling mechanism is placed on a top of the fixing frame, and comprises a manipulator and a handling assembly connected to the manipulator.
